(19) United States
(12) Patent Application Publication
(10) Pub. No.: US 2020/0156975 A1
(43) Pub. Date: May 21, 2020

(54) METHOD OF UPGRADING THE ACTIVATED SLUDGE PROCESS BASED ON FUNCTIONAL SUSPENDED CARRIERS IN THE WASTEWATER BIOLOGICAL TREATMENT PROCESS

(71) Applicant: DALIAN UNIVERSITY OF TECHNOLOGY, Dalian, Liaoning (CN)

(72) Inventors: Xie QUAN, Dalian, Liaoning (CN); Yanjun MAO, Dalian, Liaoning (CN); Yaobin ZHANG, Dalian, Liaoning (CN); Shuo CHEN, Dalian, Liaoning (CN)

(21) Appl. No.: 16/621,226

(22) PCT Filed: Mar. 8, 2018
(86) PCT No.: PCT/CN2018/078443

§ 371 Date: Dec. 10, 2019

(51) Int. Cl. C02F 3/30; C02F 3/10; C02F 3/20; C02F 101/10

(52) U.S. Cl. CPC C02F 3/308; C02F 3/10; C02F 3/301; C02F 2101/105; C02F 2203/006; C02F 2301/04; C02F 3/201

(57) ABSTRACT

A method of upgrading the activated sludge process based on functional suspended carriers in the wastewater biological treatment process. The reaction zone of the original activated sludge process is divided into an aerobic zone, anoxic zone, first aerobic zone and second aerobic zone without increasing the footprint and extending the original process. A certain amount of functional suspended carriers is added in each reactor according to the treatment requirements, and influent diversion is used, in order to improve the pollutant removal performance of the modification process. Furthermore, the effluent quality can meet the requirements of discharge standards. This method is especially suitable for the upgrading of built wastewater treatment plants.

### TECHNICAL FIELD

The present invention relates to a method of upgrading the activated sludge process based on functional suspended carriers in the wastewater biological treatment process, belongs to the technical field of wastewater biological treatment.

### BACKGROUND

Currently, the activated sludge process (including single activated sludge process, A²O and AO process, oxidation ditch process, etc.) is mainly used in the existing secondary biochemical treatment units of wastewater treatment plants. According to the discharge standard of pollutants for wastewater treatment plant at that time, the removal of organic matter (COD, BOD) and suspended solids (SS) was the main task in many wastewater treatment plants. After the implementation of new discharge standard, the existing wastewater treatment plants with lower design standard generally have problems such as low wastewater treatment efficiency, low attainment rate, excessive discharge of pollutants and so on. Therefore, these wastewater treatment plants have to be upgraded in order to meet the new discharge standard. The key to solve the problem of water environmental pollution is that a high-efficiency wastewater treatment technology could be developed as soon as possible, which can modify the original treatment technology and improve the performance of the treatment process without larger changes of the original treatment technology. The wastewater biological treatment process based on suspended biofilm carrier is a combined wastewater treatment process that can complete the upgrading by using the original structure without adding new footprint and extending process. It can greatly reduce the investment cost and operation cost, and overcome the key technical bottleneck that restricts the upgrading of wastewater treatment. However, there are still some non-ignorable problems in the use of traditional biofilm carriers, such as bad biocompatibility, slow biofilm formation, low efficiency of wastewater treatment and so on, which restrict the further development and application of this process. In order to address the problems above, the object of the present invention is to apply the enhanced wastewater biological treatment process based on functional suspended carriers in the upgrading of the activated sludge process for the wastewater biological treatment.

### SUMMARY

In view of the problems occurred in the existing wastewater treatment plants such as low wastewater treatment efficiency, low attainment rate and excessive discharge of pollutants, the object of the present invention is to provide a method of upgrading the activated sludge process by adding functional suspended carriers in the wastewater biological treatment process.

The technical solutions of the present invention are as follows:

A method of upgrading the activated sludge process based on functional suspended carriers in the wastewater biological treatment process, which includes the following steps:

(1) Activated sludge reactor is divided into anaerobic zone, anoxic zone, aerobic zone 1 and aerobic zone 2 by partition walls. In order to improve the biodegradability of the system (BOD₅/COD>0.3), functional biofilm carriers are added in the anaerobic zone to enhance the oxidative (reductive) degradation capability of organic pollutants (especially for refractory organic pollutants) by microbes in water. The functional suspended carriers are made of graphene oxide and/or biochar as the functional materials and polyethylene as the basic raw material by physical blending and screw extrusion. Electrophilic suspended biofilm carriers are added in anoxic zone, aerobic zone 1 and aerobic zone 2. The surface of nitrifying bacteria and denitrifying bacteria in biochemical wastewater treatment system are generally electronegativity. Adding electrophilic suspended biofilm carriers with electropositive surface in the anoxic and aerobic zones is beneficial to enhance the enrichment of anoxic denitrifying bacteria and aerobic nitrifying bacteria on the carrier surface, so as to improve the denitrification performance in the anoxic zone and the simultaneous nitrification-denitrification performance in the aerobic zone. The electrophilic suspended carriers are made of electrophilic polymer as functional materials and polyethylene as basic raw materials by physical blending and screw extrusion.

(2) Influent diversion (i.e. the wastewater was fed from the front of anaerobic zone and anoxic zone respectively) is adopted so that some wastewater can be fed to the anoxic zone. The way can avoid excessive consumption of influent carbon sources in the anaerobic zone, and provide more carbon sources for heterotrophic denitrifying bacteria and denitrifying phosphorus accumulating bacteria, thus improving the performance of denitrifying phosphorus removal.

(3) The nitrate is refluxed from the end of the aerobic zone 2 to the front of the anoxic zone, and the reflux ratio is more than 50%.

(4) The reflux sludge is refluxed from the biochemical secondary settling tank to the front of the anaerobic zone, and the reflux ratio is more than 100%.

(5) The way of influent diversion: the influent diversion ratio (feeding to anaerobic zone and anoxic zone) is 1:0.25-4;

The main function of aerobic zone 1 is to remove organic pollutants in water and reduce COD concentration of effluent, so as to meet the requirements of discharge standard. The main function of aerobic zone 2 is to improve the nitrogen removal of the system by enhancing nitrification and simultaneous nitrification and denitrification.

The suspended carrier content of the anaerobic zone, anoxic zone, aerobic zone 1 and aerobic zone 2 is not more than 50% of the effective volume of each reactor.

In order to obtain the full mixing and contact of “wastewater-suspended carrier-activated sludge-oxygen (aerobic zone)” in each reactor, mechanical stirring is used in the anaerobic zone and anoxic zone, while microporous aeration is used at the bottom of the aerobic zone 1 and aerobic zone 2.

The beneficial effects of the present invention are as follows: the method of upgrading the activated sludge process based on adding functional suspended carriers in the wastewater biological treatment process is an efficient upgrading technology of wastewater biological treatment process, owing to simple implement, no demand of adding new footprint and extending the original process, and low energy consumption.

### DETAILED DESCRIPTION

Detailed embodiments of the present invention are described below in conjunction with the technical solutions.

### Embodiment 1

The upgrading and expansion methods of municipal wastewater treatment plants are as follows: (1) the effective volume ratio of anaerobic zone, anoxic zone, aerobic zone 1 and aerobic zone 2 was 1:2: 2: 2; (2) the influent diversion ratio of feeding to anaerobic zone and anoxic zone respectively was 1: 1; (3) the reflux ratio of nitrate and reflux sludge were 100% and 50%, respectively; (3) the functional carrier content of the anaerobic zone, anoxic zone, aerobic zone 1 and aerobic zone 2 accounted for 15%, 30%,30% and 45% of the effective volume of each reactor, respectively. (4) the hydraulic retention time of anaerobic zone, anoxic zone, aerobic zone 1 and zone 2 were 2, 4, 4 and 4 hours respectively; (5) the dissolved oxygen concentration in anaerobic zone and anoxic zone were below 0.1 mg/L, while that value in aerobic zone 1 and aerobic zone 2 were maintained at 2-3 mg/L. The operation results showed that compared with the original activated sludge process, the wastewater biological treatment process based on functional suspended carrier not only shortened the hydraulic retention time (6 hours shorter than the original activated sludge process) and increased the removal rates of COD, NH₄⁺−N, TN and TP by more than 20%, 45%, 35% and 25% respectively, but also made the effluent quality meet the requirements (COD<50 mg/L, NH₄⁺−N<5 mg/L, TN<8 mg/L, TP<1 mg/L) of Class I (A) of Discharge Standard of Pollutants for Municipal Wastewater Treatment Plant of China (GB18918-2002).

### Embodiment 2

The upgrading and expansion methods of industrial wastewater treatment plants are as follows: (1) the effective volume ratio of anaerobic zone, anoxic zone, aerobic zone 1 and aerobic zone 2 was 1:2: 2: 1; (2) the influent split ratio of feeding to anaerobic zone and anoxic zone respectively was 1: 2; (3) the reflux ratio of nitrate and reflux sludge were 200% and 100%, respectively; (4) the functional carrier content of the anaerobic zone, anoxic zone, aerobic zone 1 and aerobic zone 2accounted for 20%, 30%, 40% and 40% of the effective volume of each reactor, respectively. (5) the hydraulic retention time of anaerobic zone, anoxic zone, aerobic zone 1 and zone 2 were 8, 16, 16 and 8 hours respectively; (6) the dissolved oxygen concentration in anaerobic zone and anoxic zone were below 0.1 mg/L, while that value in aerobic zone 1 and aerobic zone 2 were maintained at 3-4 mg/L. The operation results showed that compared with the original activated sludge process, the wastewater biological treatment process based on functional suspended carrier not only shortened the hydraulic retention time (16 hours shorter than the original activated sludge process), but also increased the removal rates of COD, NH₄⁺−N, TN and TP by more than 20%, 45%, 35% and 25% respectively.

1. A method of upgrading the activated sludge process based on functional suspended carriers the wastewater biological treatment process, wherein comprising the following steps:
activated sludge reactor is divided into anaerobic zone, anoxic zone, first aerobic zone and second aerobic zone by partition wall, in which functional biofilm carriers are added in anaerobic zone, while electrophilic suspended biofilm carriers are added in anoxic zone, first aerobic zone and second aerobic zone;
influent diversion, in which the wastewater is fed from the front of anaerobic zone and anoxic zone respectively, is adopted to lead some wastewater into the anoxic zone, and avoid excessive consumption of influent carbon sources in the anaerobic zone due to feeding wastewater only from the anaerobic zone, and provide more carbon sources for heterotrophic denitrifying bacteria and denitrifying phosphorus accumulating bacteria, thus improving the performance of denitrifying phosphorus removal;
the nitrate is refluxed from the end of the second aerobic zone to the front of the anoxic zone, and the reflux ratio is more than 50%;
the reflux sludge is refluxed from the biochemical secondary settling tank to the front of the anaerobic zone, and the reflux ratio is more than 100%;
the way of influent diversion: the influent diversion ratio, feeding to anaerobic zone and anoxic zone, is 1:0.25-4.

2. The method of upgrading the activated sludge process based on functional suspended carriers in the wastewater biological treatment process according to claim 1, wherein, the percentage of added functional biofilm carriers in the anaerobic zone is less than 50% of the effective volume of the anaerobic zone; and the percentage of electrophilic suspended biofilm carriers in the anoxic zone, first aerobic zone and second aerobic zone is less than 50% of the effective volume of each reactor.

3. The method of upgrading the activated sludge process based on functional suspended carriers in the wastewater biological treatment process according to claim 1, wherein, mechanical stirring is used in the anaerobic zone and anoxic zone, while microporous aeration is used at the bottom of the first aerobic zone and second aerobic zone, in order to obtain the full mixing of “wastewater-suspended carrier-activated sludge-oxygen ” in each reactor.

4. The method of upgrading the activated sludge process based on functional suspended carriers in the wastewater biological treatment process according to claim 2, wherein, mechanical stirring is used in the anaerobic zone and anoxic zone, while microporous aeration is used at the bottom of the first aerobic zone and second aerobic zone, in order to obtain the full mixing of “wastewater-suspended carrier-activated sludge-oxygen” in each reactor.
